(19) United States
(12) Patent Application Publication
(10) Pub. No.: US 2015/0351455 A1
(43) Pub. Date: Dec. 10, 2015

(54) ELECTRONIC CIGARETTE AND ELECTRONIC CIGARETTE DEVICE THEREOF

(71) Applicant: KIMREE HI-TECH INC., Tortola (VG)

(72) Inventor: QIUMING LIU, Huizhou City, Guangdong Province (CN)

(21) Appl. No.: 14/412,441

(22) PCT Filed: Dec. 11, 2012
(86) PCT No.: PCT/CN2012/086367

§ 371 Date: Aug. 24, 2015

(51) Int. Cl. A24F 47/00; H01M 2/10

(52) U.S. Cl. CPC A24F 47/008; H01M 2/1055; H01M 2220/30

(57) ABSTRACT

An electronic cigarette is provided. The electronic cigarette comprises a main rod body, a battery chamber provided with an opening is arranged on a side wall of the main rod body or on an end surface of the main rod body inside the main rod body, and a battery cover capable of being opened and closed is arranged at the opening. The electronic cigarette further comprises a battery placed in the battery chamber in a detachable manner, and a positive pole contact member and a negative pole contact member which are correspondingly in butted joint with a positive pole and a negative pole of the battery are arranged inside the battery chamber. The electronic cigarette has a battery replacement function, and thus can be reused.

### FIELD OF THE INVENTION

The present invention relates to electronic cigarette and cigarette case, particularly relates to an electronic cigarette and an electronic cigarette device with a replaceable battery.

### BACKGROUND OF THE INVENTION

With a deep knowledge about harm of smoking, to give up smoking is the common aim of most smokers, accordingly, an electronic cigarette as substitute for traditional cigarette, are gradually received by smokers.

Traditional electronic cigarette is composed of both an inhaling rod and a battery rod, its inhaling rod is equipped with a mouthpiece and an atomization device for vaporizing cigarette liquid, the battery rod generally has a battery and a control switch therein, the battery is used for providing power, the control switch is used for controlling whole operation of the electronic cigarette. The battery of existing electronic cigarette is integrated and fixed in the battery rod, and cannot be detached and replaced, thus maintenance is difficult, when the battery in the battery rod is exhausted or damaged, the whole battery rod or even the whole electronic cigarette shall be abandoned, which causes big waste, and accordingly rises the cost of the smoker.

### SUMMARY OF THE INVENTION

An objective of the present invention provides an electronic cigarette, of which a battery is separated from a main rod body, whereby the battery can be replaced and the electronic cigarette can be reused so as to avoid waste and cut down smoker's cost.

To achieve the aforementioned objective, the present invention provides an electronic cigarette, including an main rod body, herein, the main rod body defines a battery chamber therein with an opening at a sidewall of the main rod body or at an end surface of the main rod body, a battery cover capable of being opened or closed is set on the opening; the electronic cigarette further comprises a detachable battery disposed in the battery chamber, a positive pole contact member and a negative pole contact member are set in the battery chamber and correspondingly connected with positive and negative poles of the battery.

In accordance with an embodiment, the positive pole contact member is set on a wall of the battery chamber facing the positive pole of the battery, and the negative pole contact member is set on an inside wall of the battery cover.

In accordance with an embodiment, the positive pole contact member and the negative pole contact member are set on a wall of the battery chamber respectively facing the positive pole and negative pole of the battery.

In accordance with an embodiment, the negative pole contact member is a compressible spring or an elastic piece.

In accordance with an embodiment, the positive pole contact member is a compressible spring or an elastic piece.

In accordance with an embodiment, at least one battery fixing seat is set in the battery chamber, the battery fixing seat defines a fixing hole with an inner diameter adapted to the battery, and the battery is fitted in the fixing hole.

In accordance with an embodiment, the battery cover and the main rod body are connected by means of thread connection, clamp connection or inserting connection.

In accordance with an embodiment, the battery cover and the main rod body are made from conductive materials; or, contact portions between the battery cover and the main rod body respectively form conductive parts of conductive materials which are coupled to each other when the battery cover is fitted on the main rod body, and the conductive part set on the battery cover is electrically connected with the negative pole contact member.

In accordance with an embodiment, the main rod body is a battery rod, the electronic cigarette further comprises an inhaling rod interconnected with the battery rod, one end of the inhaling rod is equipped with a mouthpiece, the other end of the same is provided with a connector interconnected with the battery rod, an inner of the inhaling rod is further provided with an atomization device and an atomization control unit used for controlling the atomization device switched on or off, and the atomization control unit comprises an atomization control circuit and an atomization control switch electrically connected with the atomization control circuit.

In accordance with an embodiment, one end of the main rod body is equipped with a mouthpiece, an inner of the main rod body is further provided with an atomization device and an atomization control unit used for controlling the atomization device switched on or off which are electrically connected with the positive pole contact member and the negative pole contact member, and the atomization control unit comprises an atomization control circuit and an atomization control switch electrically connected with the atomization control circuit.

In accordance with an embodiment, the atomization control switch is a capacitive sensor switch or an airflow sensor switch.

In accordance with an embodiment, the atomization control circuit is integrated in the atomization control switch.

In accordance with an embodiment, the atomization control unit further comprises an atomization control board respectively connected with the battery and the atomization control switch, and the atomization control circuit is integrated in the atomization control circuit board.

In accordance with an embodiment, the atomization control switch is a keyswitch, the atomization control unit further comprises an atomization control board respectively connected with the battery and the keyswitch, and the atomization control circuit is integrated in the atomization control circuit board.

Another objective of the present invention is to provide with an electronic cigarette device, a battery of the electronic cigarette in the same is replaceable.

To achieve the above objective, the present invention further provides an electronic cigarette device, comprising an electronic cigarette case and an electronic cigarette accommodated in the electronic cigarette case, herein, the electronic cigarette is the same as described above.

The advantage of the present invention are: the main rod body defines the battery chamber with the opening, and the battery cover is set on the opening in a way that can be opened or closed, at the same time, the battery is detachably mounted in the battery chamber, therefore, the battery in the electronic cigarette can be easily replaced, the electronic cigarette is reusable, energy is saved and environment is protected, and the user's cost for smoking is highly cut down.

Embodiments of the present invention will now be described, with reference to the attached Figures.

### BRIEF DESCRIPTION OF THE DRAWINGS

FIG. 1 is a cross-sectional view of an electronic cigarette in accordance with an embodiment of the present invention.

FIG. 2 is a perspective view of a battery rod of the electronic cigarette in accordance with an embodiment of the present invention.

FIG. 3 is a cross-sectional view of the battery rod of the electronic cigarette in accordance with the first embodiment of the present invention.

FIG. 4 is an exploded view of the battery rod of the electronic cigarette in accordance with the first embodiment of the present invention.

FIG. 5 is of a cross-sectional view of the battery rod of the electronic cigarette in accordance with the second embodiment of the present invention.

FIG. 6 is an exploded view of the battery rod of the electronic cigarette in accordance with the second embodiment of the present invention.

FIG. 7 is a cross-sectional view of an inhaling rod of the electronic cigarette in accordance with an embodiment of the present invention.

FIG. 8 is a perspective view of an electronic cigarette device in accordance with an embodiment of the present invention.

### DETAILED DESCRIPTION OF THE INVENTION

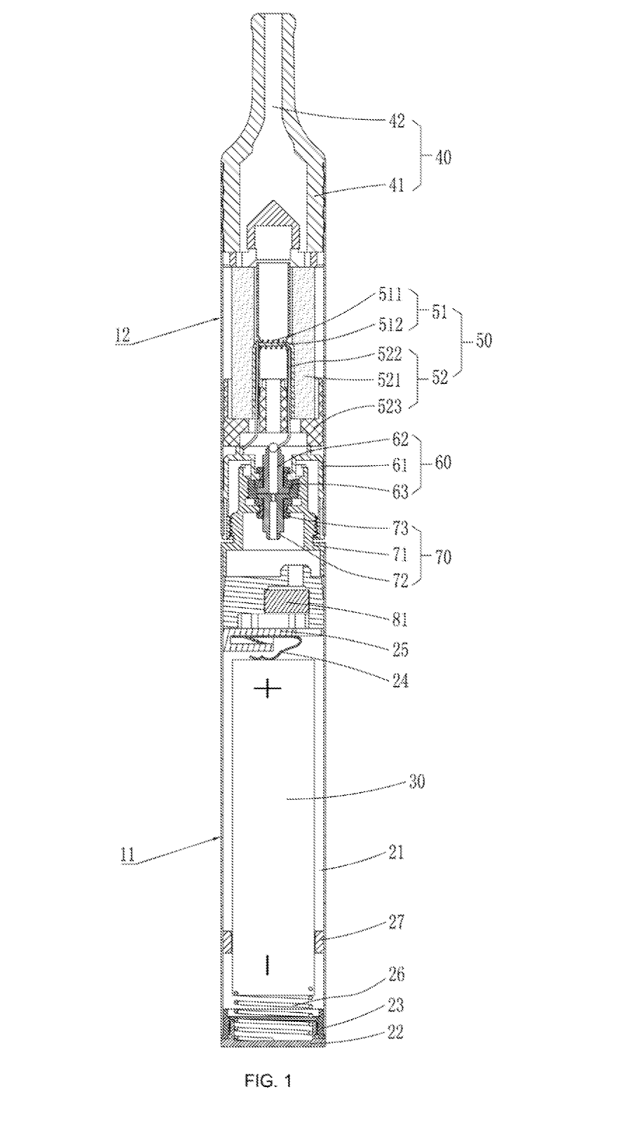

Referring to FIG. 1 to FIG. 8, an electronic cigarette device is provided in accordance with an embodiment of the present invention, comprising an electronic cigarette 100 and an electronic cigarette case 200 encasing the electronic cigarette 100.

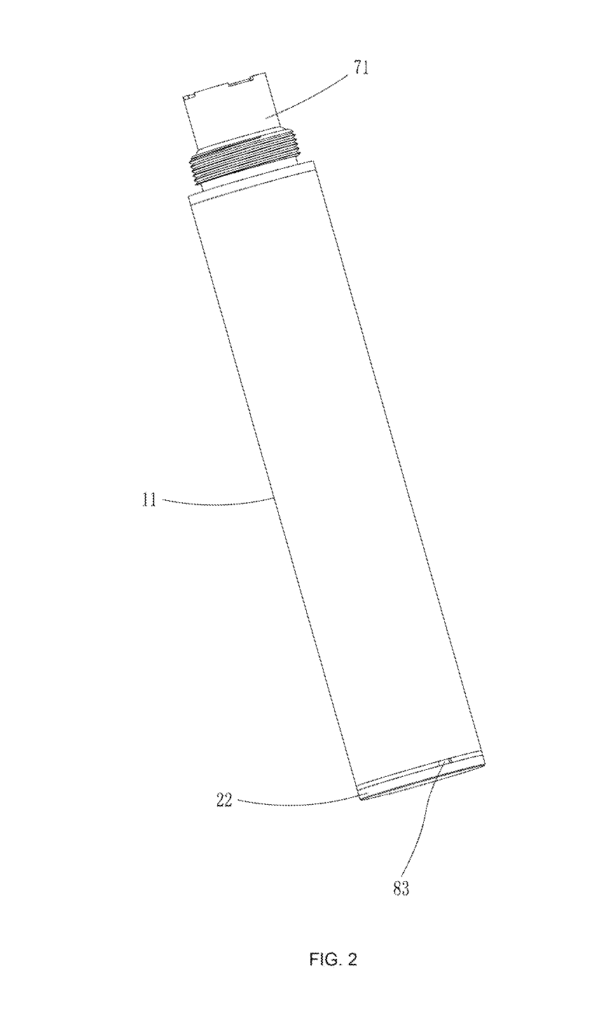

Referring to FIGS. 2 to 6, the electronic cigarette 100 comprising a main rod body 11, the main rod body 11 defines a battery chamber 21 therein, the battery chamber 21 has an opening in a sidewall of the main rod body 11 or in an end surface of the main rod body 11, and a battery cover 22 capable of being opened or closed is equipped to the opening. The electronic cigarette 100 further comprises a battery 30 detachably mounted in battery chamber 21, and there are positive pole contact member and negative pole contact member set in the battery chamber 21 for correspondingly connecting positive and negative poles of the battery 30.

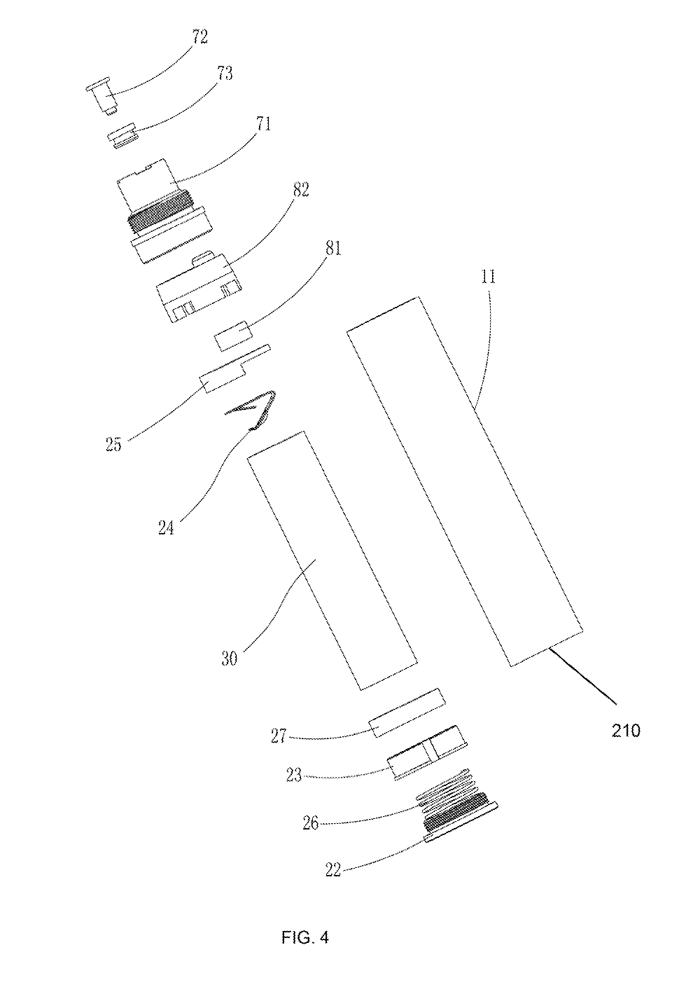

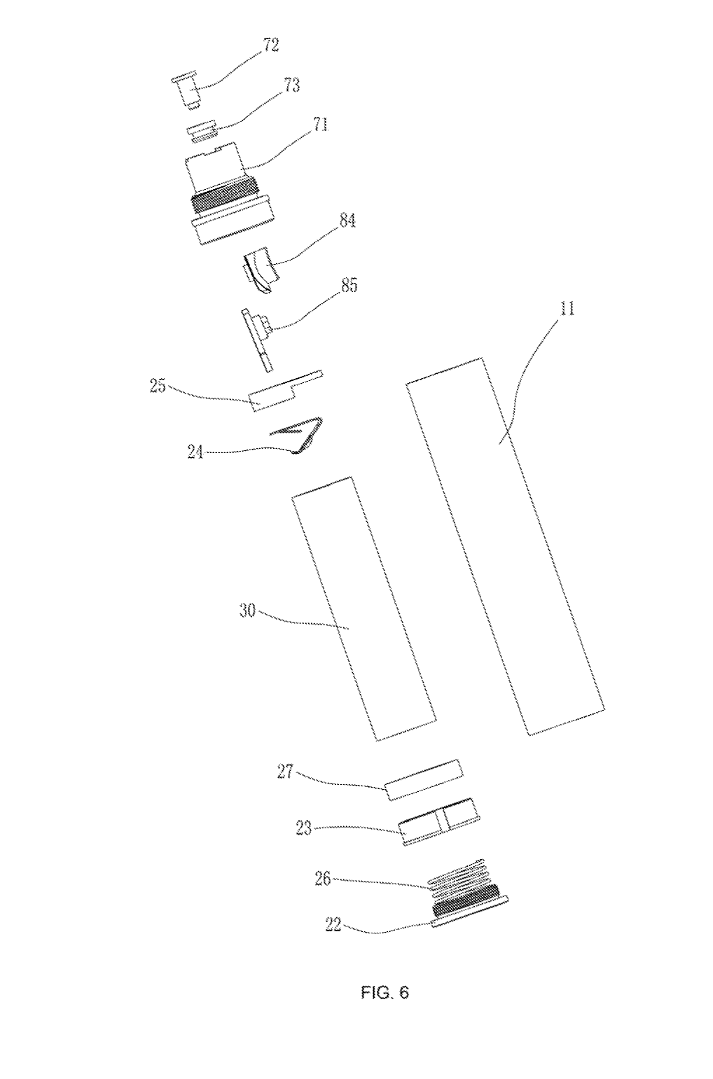

Referring to FIGS. 4 and 6, in accordance with this embodiment, the main rod body 11 is shaped as a cylindrical tube, which is hollow inside in such way to form an accommodated cavity for every inner components thereof. It is understood that, the main rod body 11 can be configured as a hollow tube in various shapes, and not limited to the cylinder in this embodiment.

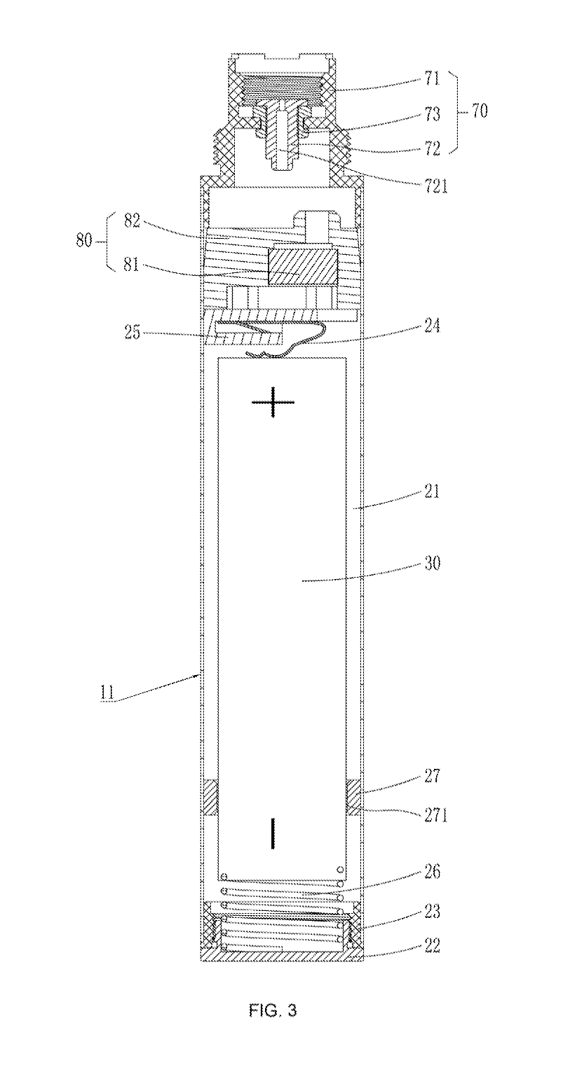

Referring to FIGS. 3 to 6, in accordance with the embodiment, the opening of the battery chamber 21 is set at a distal end of the main rod body 11, and the battery cover 22 is correspondingly set on the open end. Particularly, a fastening sheath 23 is set inside the opening end of the main rod body 11, the fastening sheath 23 forms internal threads on its inside wall, and an corresponding end of the battery cover 22 forms coupling external threads, and thus both of the same are connected by threads. Certainly, one end of the fastening sheath 23 may also be configured as a protrusion extending out from the main rod body 11, and the protrusion forms external threads on its outside wall, while the battery cover 22 correspondingly forms internal threads; otherwise, the battery cover 22 and the main rod body 11 may also connect with each other by means of fastening or inserting.

Referring to FIGS. 3 and 6, in accordance with the embodiment, the battery 30 has its positive and negative poles disposed at two opposite sides thereof, the positive pole contact member is disposed at the wall of the battery chamber 21 facing the positive pole of the battery 30, while the negative pole contact member is disposed at the inside wall of the battery cover 22. As an embodiment, the positive and negative poles of the battery 30 can be arranged at any side of the battery 30 if necessary, while the positive pole contact member and the negative pole contact member are disposed at the wall of the battery chamber 21 respectively facing the positive pole and negative pole of the battery 30.

In accordance with the embodiment, the positive pole contact member is an elastic piece 24 disposed at one side of the battery 30 far away from the battery cover 22, the elastic piece 24 is mounted in the main rod body 11 via an elastic piece fixing seat 25; while the negative pole contact member is a compressive spring 26 disposed at one side of the battery 30 facing the battery cover 22. As an embodiment, the negative pole contact member may also be configured as an elastic piece, and the positive pole contact member may also be configured as a compressive spring.

In accordance with the embodiment, the battery cover 22 and the main rod body 11 are made from conductive materials; or, the contact areas between the battery cover 22 and the main rod body 11 respectively forms conductive parts from conductive materials are interconnected when the battery cover 22 covers the main rod body 11, and the conductive part on the battery cover 22 is electrically connected with the negative pole contact member.

In accordance with the embodiment, the battery chamber 21 is defined by the inner wall of the main rod body 11, the elastic piece fixing seat 25 and the battery cover 22; the battery 30 has a diameter smaller than the inner diameter of the main rod body 11; at least one battery fixing seat 27 is provided in the battery chamber 21 for fixing the battery 30 and preventing the same radially moving in the battery chamber 21; the battery fixing seat 27 defines a fixing hole 271 therethrough with an inner diameter corresponding to the battery 30, and the battery 30 is fixed in the fixing hole 271 of the battery fixing seat 27.

When to mount the battery 30, let the positive pole of the battery 30 face the battery chamber 21, pass the battery 30 through the fixing hole 271 of the battery fixing seat 27, and then the battery 30 is placed into the battery chamber 21; let the corresponding end of the battery cover 22 face the opening of the battery chamber 21, let the compression spring 26 resist against the negative pole of the battery 30; screw up the battery cover 22, the battery cover 22 comes to press the compression spring 26 until the battery cover 22 is tightly fixed to the main rod body 11; herein, the battery 30 is tightly fixed in the battery chamber 21 under the force of the compression spring 26.

Generally, one end of the electronic cigarette 100 is provided with the battery 30 and the other end thereof is provided with a mouthpiece 40, the electronic cigarette 100 is often divided into two parts as an inhaling rod 12 and a battery rod according to its inner components and functions; the inhaling rod 12 and the battery rod may be detachably connected, or may be an inseparably integrated structure. When the inhaling rod 12 and the battery rod are detachably connected, then the main rod body 11 is the battery rod; when the inhaling rod 12 and the battery rod are configured as an inseparably integrated structure, and then the main rod body 11 is used as both the inhaling rod 12 and the battery rod of the electronic cigarette 100 at the same time.

Referring to FIG. 1, in accordance with the embodiment, the inhaling rod 12 and the battery rod are detachable, and the electronic cigarette 100 is described in detail as follows.

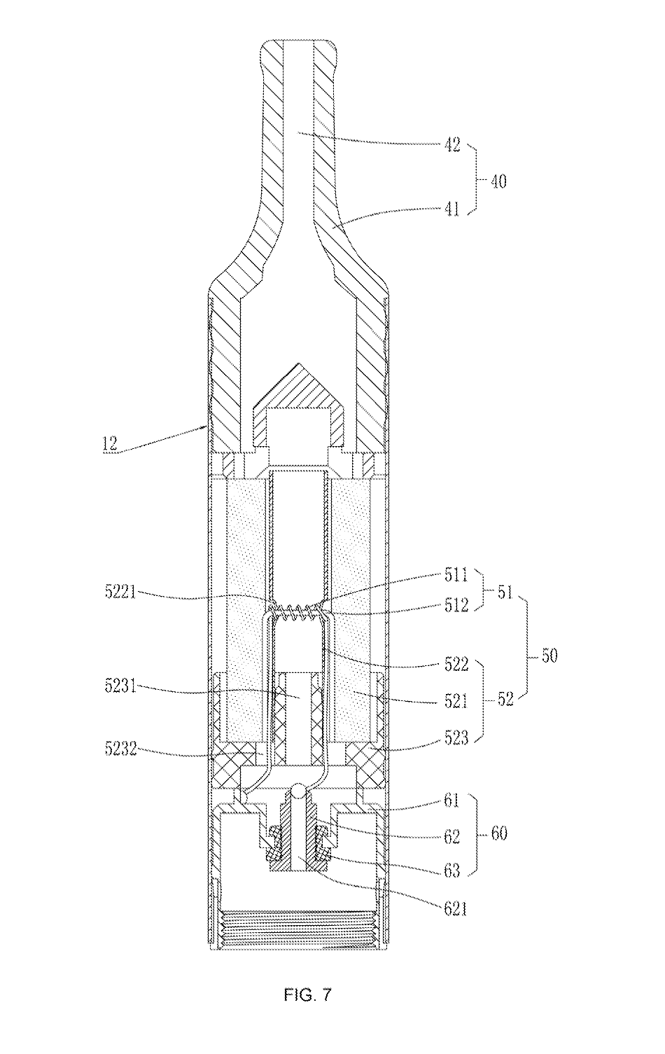

Referring to FIGS. 1 and 7, the mouthpiece 40 is provided at one end of the inhaling rod 12 far from the main rod body 11; in this embodiment, the mouthpiece 40 and the inhaling rod 12 are separable, comprises a mouthpiece cover 41 inserted to the distal end of the inhaling rod 12, and axially defines a suction hole 42 through a center of the mouthpiece cover 41. As another embodiment, the mouthpiece 40 and the inhaling rod 12 may be integrated. In this embodiment, the mouthpiece 40 forms a tapered sleeve with its diameter becoming smaller towards the distal end of the mouthpiece 40. It is understood that, the mouthpiece 40 is further configured as a cylindrical or any other hollow tube. Further referring to FIGS. 1 and 7, the inhaling rod 12 therein is further provided with an atomization device 50 between the mouthpiece 40 and the battery 30, the atomization device 50 electronically connected with the battery and used for vaporizing cigarette liquid, the atomization device 50 may be any atomization structure which can vaporize cigarette liquid, in this embodiment, the atomization device 50 comprises an atomizer 51 and an atomizing cup 52 for accommodating the atomizer 51.

The atomizer 51 is used for vaporizing cigarette liquid into smog, comprising an electric heat wire 511 and a fiber piece 512; the electric heat wire 511 winds around the fiber piece 512, and is mounted in the atomizing cup 52 via the fiber piece 512. In this embodiment, the fiber piece 512 may be made from glass fiber or other heat-resistant fiber, can absorb cigarette liquid for the electric heat wire 511 to vaporize cigarette liquid, and has a shape of cylinder.

The atomizing cup 52 comprises a liquid storage member 521, a supporting tube 522, and an atomizing seat 523, herein, the liquid storage member 521 and the supporting tube 522 are shaped about a cylinder and coaxially fitted with each other.

the liquid storage member 521 is a hollow cylinder, can absorb and store liquid as a sponge, is used to absorb and store cigarette liquid so that the atomizer 51 can continue to vaporize cigarette liquid, in this embodiment, the liquid storage member 521 may be made from glass fiber, heat-resistant cotton-like materials, chemical fiber cotton-like materials, mixed cotton-like materials, liquid absorption cotton-like materials, foamed nickel and so on.

The supporting tube 522 also is a cylinder, and made from glass fiber, the supporting tube 522 is fitted in the liquid storage member 521 so as to fix the liquid storage member 521 in the inhaling rod 12, and is used to connect gas passage and support the liquid storage member 521. The supporting tube 522 defines apertures 5221 radially through upper sidewall of the supporting tube 522, the apertures 5221 is used for tightly mounting the fiber piece 512 of the atomizer 522. The fiber piece 512 has its two ends extending from the apertures 5221 and contacting the inside wall of the liquid storage member 521 so as to absorb cigarette liquid in the liquid storage member 521 for the electric heat wire 511 performing vaporization.

The atomizing seat 523 is used for supporting and fixing the atomizer 51, the liquid storage member 521 and the supporting tube 522, and the mouthpiece cover 41 respectively seal two ends of the atomizing cup 52 so as to form a cup body of the atomizing cup 52. The atomizing seat 523 can be made from plastic, has a shape and dimension adapted to the inside wall of the inhaling rod 12, and is tightly fitted in the inhaling rod 12 with the outside wall. In this embodiment, the atomizing seat 523 defines an axial through gas port 5231 and at least two wire through holes 5232 for passing electric heat wire 511.

In this embodiment, the inhaling rod 12 can be directly used as the cup body of the atomizing cup 52, otherwise, a separate cup body is further coaxially set in the inhaling rod 12.

Referring to FIG. 1, a first connector 60 and a second connector 70 are respectively provided at connecting portions of the inhaling rod 12 and the battery rod so that both the same are tightly connected and electrically connected.

Referring to FIG. 7, the first connector 60 is set in one end of the inhaling rod 12 near the battery rod, and the first connector 60 and the mouthpiece 40 are respectively disposed at two ends of the inhaling rod 12 so as to seal and fix the atomization device 50 in the inhaling rod 12.

In this embodiment, the first connector 60 comprises a first connecting piece 61 and a first electrode 62, and the first connecting piece 61 and the first electrode 62 are fixed together by a first insulation ring 63.

The first connecting piece 61 is a hollow tube like, is tightly fixed in the distal end of the inhaling rod 12 far from the mouthpiece 40 and contacts the atomization device 50, and its center radially and inwards extends to form a mounting flange for holding the first insulation ring 63.

The first electrode 62 is configured adapted to the first connecting piece 61, is fitted in the first connecting piece 61 using the first insulation ring 63. In this embodiment, the first electrode 62 is hollow tube like too, its hollow center forms a first air inlet 621 for environmental air entering into the atomization device 50.

In this embodiment, the first connecting piece 61 is made form metal conductive materials, such as cupper or the like, it is used as a negative electrode of the atomization device 50 electrically connected with the negative pole of the battery 310, the first electrode 62 is used as a positive electrode of the atomization device 50 electrically connected with the positive pole of the battery 30, and both ends of the electric heat wire 511 are respectively electrically connected with the first connecting piece 61 and the first electrode 62 by means of soldering connection, rivet connection, or clamp connection etc.

In detail, in accordance with the embodiment, the electric heat wire 511 winds around the fiber piece 512, one end of the same bends and passes the corresponding wire through hole 5232 in the atomizing seat 523 and is finally soldered with the first connecting piece 61, the other end bends and passes the corresponding wire through hole 5232 in the atomizing seat 523 and is finally soldered with the first electrode 62.

Referring to FIGS. 3 and 6, the second connector 70 has a similar structure as the first connector 60, comprising a second connecting piece 71, a second electrode 72, and the second connecting piece 71 and the second connecting piece 72 are fixed together by means of a second insulation ring 73.

The second connecting piece 71 is a hollow tubular structure, is fitted in the end of battery rod far from the battery cover 22, and its center radially and inwards extends to form a mounting flange for holding the second insulation ring 73.

The second electrode 72 is adapted to the second connecting piece 71, is fitted in the second connecting piece 71 and insulated from the second connecting piece 71 via the second insulation ring 73. In this embodiment, the first electrode 62 is a hollow tubular structure, forms a second air inlet 721 in its center communicated with the first air inlet 621.

In this embodiment, the second connecting piece 71 is made from metal conductive materials too, the first connecting piece 61 is electrically connected with the negative pole of the battery 30 through the second connecting piece 71. The first electrode 62 is electrically connected with the positive pole of the battery 30 through the second electrode 72. As an embodiment, when the inhaling rod 12 and the battery rod is configured as an integrated structure, the inhaling rod 12 and the battery rod will not set the first connector 60 or the second connector 70, but two ends of the electric heat wire 511 are directly electrically connected with the positive and negative poles of the battery 30.

Referring to FIG. 1, in this embodiment, the inhaling rod 12 and the battery rod are preferably threadedly connected, accordingly the first connecting piece 61 and the second connecting piece 71 set matching threads at their connecting portions. Certainly, the inhaling rod 12 and the battery rod may be connected by means of clamp connection, inserting connection or other connection manners, thus the first connecting piece 61 and the second connecting piece 71 are set with the corresponding connection structure.

Referring to FIGS. 3 to 6, the battery rod is further equipped with an atomization control unit 80, the atomization control unit 80 comprises an atomization control circuit and an atomization control switch. In accordance with the embodiment, the atomization control unit 80 is set in the end of the battery rod near the inhaling rod 12, as an embodiment, the atomization control may be set at the end of the battery rod far from the inhaling rod 12.

Referring to FIGS. 3 and 4, in accordance with this embodiment, the atomization control switch is a sensor switch 81, and the sensor switch is mounted in the battery rod by a switch fixing seat 82. Particularly, the sensor switch 81 is a capacitive sensor switch, when the user smokes with the electronic cigarette 100; the capacitive sensor switch senses the capacitance changed after air is inhaled, and then controls the atomization control circuit connected to the power supply, thus the electronic cigarette starts to work. As an embodiment, the sensor switch 81 may be an airflow sensor switch, when the user inhales the mouthpiece 40, inner of the electronic cigarette 100 produces negative pressure thus the airflow sensor switch 81 produces pulse signals to control the atomization control circuit connected with the power supply.

Because the sensor switch 81 is precisely made, and generally a built-in special controller is set therein, the atomization control circuit may be integrated in the controller in accordance with this embodiment; as an embodiment, the atomization control circuit may be integrated in an sensor control circuit board which is separated from the sensor switch 81 and respectively electrically connected with the sensor switch 81 and the battery 30.

In accordance with the embodiment, for a proper work of the sensor switch 81, the main rod body 11 defines air holes 83 therein communicated with environmental air at both sides of the sensor switch 81. As shown in FIG. 2 in accordance with the embodiment, the air hole 83 at the side of the sensor switch 81 near the battery 30 is defined in the battery cover 22. As an embodiment, the air hole 83 may be directly defined in the sidewall of the battery rod where the battery 30 is disposed.

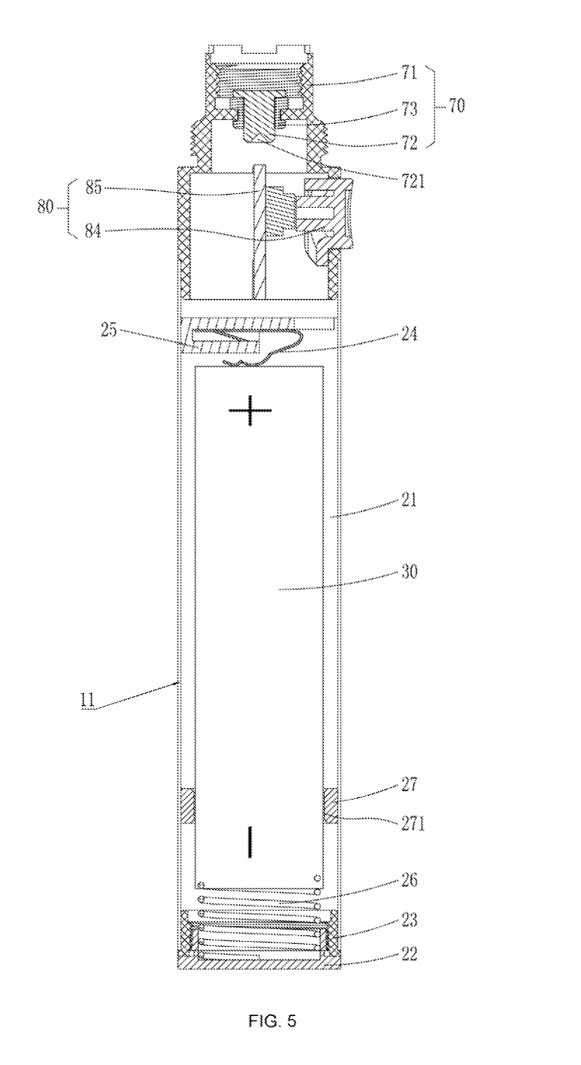

Referring to FIGS. 5 and 6, as an embodiment, the atomization control switch may be a traditional keyswitch 84, the keyswitch 84 controls a circuit board 85 via a key to be electrically connected with the battery 30 so that the atomization control circuit is controlled by key operations to switch on or off the circuit of the atomization device 50.

Now to illustrate the sensor switch 81 as the atomization control switch, when the user smokes with the electronic cigarette 100, the sensor switch 81 responses and switches on the atomization control circuit, the current direct is: from the positive pole of the battery 30 to the second electrode 72, then from the first electrode 62 to the positive electrode of the electric heat wire 511, then through the negative electrode of the electric heat wire 511 to the first connecting piece 61, finally from the outer wall of the first connecting piece 61 through the second connecting piece 71 to the negative pole of the battery 30.

It is understood that, the electronic cigarette 100 is not limited to the two embodiments as shown in FIGS. 1 to 7, all technical characteristics in each embodiment can be combined into new embodiments.

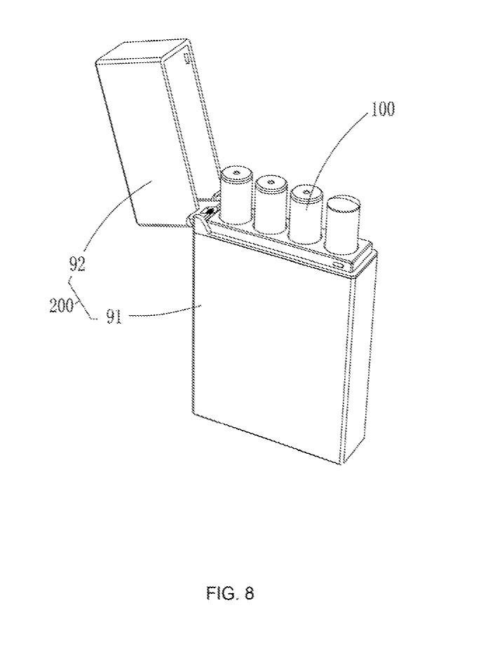

As shown in FIG. 8, the electronic cigarette 100 is often placed in an electronic cigarette case 200, the electronic cigarette case 200 comprises a case body 91 for accommodating the electronic cigarette 100 and a cover 92 set on the case body 91. The case body 91 is a square-shaped shell, of course, its shape is not limited to square, but may be circular, oval, or various shapes, only the cover 92 shall be adapted to the case body 92.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

1. An electronic cigarette, comprising a main rod body, wherein the main rod body defines a battery chamber therein with an opening at a sidewall of the main rod body or at an end surface of the main rod body, a battery cover is capable of being opened or closed is set on the opening, the electronic cigarette further comprises a detachable battery disposed in the battery chamber, a positive pole contact member and a negative pole contact member are set in the battery chamber and correspondingly connected with positive and negative poles of the battery.

2. According to the electronic cigarette in claim 1, wherein the positive pole contact member is set on a wall of the battery chamber facing the positive pole of the battery, and the negative pole contact member is set on an inside wall of the battery cover.

3. According to the electronic cigarette in claim 1, wherein the positive pole contact member and the negative pole contact member are set on a wall of the battery chamber respectively facing the positive pole and negative pole of the battery.

4. According to the electronic cigarette in claim 1, wherein the negative pole contact member is a compressible spring or an elastic piece.

5. According to the electronic cigarette in claim 1, wherein the positive pole contact member is a compressible spring or an elastic piece.

6. According to the electronic cigarette in claim 1, wherein at least one battery fixing seat is set in the battery chamber, the battery fixing seat defines a fixing hole with an inner diameter adapted to the battery, and the battery is fitted in the fixing hole.

7. According to the electronic cigarette in claim 1, wherein the battery cover and the main rod body are connected by means of thread connection, clamp connection or inserting connection.

8. According to the electronic cigarette in claim 2, wherein the battery cover and the main rod body are made from conductive materials; or, contact portions between the battery cover and the main rod body respectively form conductive parts of conductive materials which are coupled to each other when the battery cover is fitted on the main rod body, and the conductive part set on the battery cover is electrically connected with the negative pole contact member.

9. According to the electronic cigarette in claim 1, wherein the main rod body is a battery rod, the electronic cigarette further comprises an inhaling rod interconnected with the battery rod, one end of the inhaling rod is equipped with a mouthpiece, the other end of the same is provided with a connector interconnected with the battery rod, an inner of the inhaling rod is further provided with an atomization device and an atomization control unit used for controlling the atomization device switched on or off, and the atomization control unit comprises an atomization control circuit and an atomization control switch electrically connected with the atomization control circuit.

10. According to the electronic cigarette in claim 1, wherein one end of the main rod body is equipped with a mouthpiece, an inner of the main rod body is further provided with an atomization device and an atomization control unit used for controlling the atomization device switched on or off, the atomization device and the atomization control unit are respectively electrically connected with the positive pole contact member and the negative pole contact member, and the atomization control unit comprises an atomization control circuit and an atomization control switch electrically connected with the atomization control circuit.

11. According to the electronic cigarette in claim 9, wherein the atomization control switch is a capacitive sensor switch or an airflow sensor switch.

12. According to the electronic cigarette in claim 11, wherein the atomization control circuit is integrated in the atomization control switch.

13. According to the electronic cigarette in claim 9, wherein the atomization control unit further comprises an atomization control board respectively electrically connected with the battery and the atomization control switch, and the atomization control circuit is integrated in the atomization control circuit board.

14. According to the electronic cigarette in claim 13, wherein the atomization control switch is a keyswitch.

15. (canceled)

16. According to the electronic cigarette in claim 10, wherein the atomization control switch is a capacitive sensor switch or an airflow sensor switch.

17. According to the electronic cigarette in claim 16, wherein the atomization control circuit is integrated in the atomization control switch.

18. According to the electronic cigarette in claim 10, wherein the atomization control unit further comprises an atomization control board respectively electrically connected with the battery and the atomization control switch, and the atomization control circuit is integrated in the atomization control circuit board.

19. According to the electronic cigarette in claim 18, wherein the atomization control switch is a keyswitch.
